(19) United States
(12) Patent Application Publication
(10) Pub. No.: US 2016/0248848 A1
(43) Pub. Date: Aug. 25, 2016

(54) ELECTRONIC BOOK TERMINAL, INFORMATION SHARING METHOD, AND PROGRAM FOR ELECTRONIC BOOK TERMINAL

(71) Applicant: OPTiM Corporation, Saga (JP)

(72) Inventor: Shunji SUGAYA, Tokyo (JP)

(21) Appl. No.: 14/819,527

(22) Filed: Aug. 6, 2015

(30) Foreign Application Priority Data
Feb. 22, 2015 (JP) 2015-032378

(51) Int. Cl. H04L 29/08; H04L 29/06

(52) U.S. Cl. CPC H04L 67/10; H04L 67/02; H04L 65/40

(57) ABSTRACT

The invention hardly causes copyright infringement hardly occurs when the contents and the information of electronic books are shared through SNS. The electronic book terminal displays predetermined electronic book data; selects a range of the displayed electronic book data according to user's operation; checks the page number and the content of the selected range; judges whether or not the page number and the content of the selected range are transmittable to the SNS server 100; and transmits the selected range to the SNS server 100 according to the open level.

### TECHNICAL FIELD

The present invention relates to, in the field of electronic book terminals enabling a user to read electronic books, an electronic book terminal sharing information through SNS (social networking service), an information sharing method, and a program for the electronic book terminal.

### BACKGROUND ART

Recently various services have been provided to users by connecting mobile terminals to web servers, etc. through a public network. Reading electronic book, for example, is now available through tablet terminals and personal computers.

Information on electronic books can be shared on the network. For example, by utilizing SNS (social networking service), information on an electronic book that users themselves read is shared among their friends or acquaintances. For instance, Patent Document 1 discloses that to share electronic book information, the contents of the book that you are reading and the information on this electronic book are transmitted.

### CITATION LIST

### Patent Literature

Patent Document 1: JP 2013-143028 A

### SUMMARY OF INVENTION

So far, users may unintentionally infringe upon the copyright of electronic books by simply transmitting the contents of the electronic books.

The inventor of the present invention focused attention infringement on the copyright of electronic books in case of the contents and the information of the electronic books.

In view of the above-mentioned problems, an object of the present invention is, in the field of electronic book terminals enabling a user to read electronic books, to provide an electronic book terminal, an information sharing method, and a program for the electronic book terminal that hardly cause copyright infringement when the information is shared through SNS.

According to the first aspect of the present invention, an electronic book terminal communicatively connected with an SNS server sharing information among predetermined users comprising:
a display unit displaying predetermined electronic book data;
a selection receiving unit selecting a range of the displayed electronic book data according to user's operation;
a selected range checking unit checking the page number and the content of the selected range;
an open level judging unit judging whether or not the page number and the content of the selected range are transmittable to the SNS server; and
an SNS posting unit transmitting the selected range to the SNS server according to the open level.

According to the first aspect of the present invention, an electronic book terminal communicatively connected with an SNS server sharing information among predetermined users displays predetermined electronic book data; selects a range of the displayed electronic book data according to user's operation; checks the page number and the content of the selected range; judges whether or not the page number and the content of the selected range are transmittable to the SNS server; and transmits the selected range to the SNS server according to the open level.

Although the present invention according to the first aspect of the present invention comes into the category of an electronic book terminal, an information sharing method, and a program for the electronic book terminal also show the same operation effect.

According to the second aspect of the present invention, the electronic book terminal according to the first aspect of the present invention, further includes:
a review receiving unit receiving a review from a user for the selected range; and
an SNS posting unit transmitting the received review to the SNS server.

According to the second aspect of the present invention, the electronic book terminal according to the first aspect of the present invention receives a review from a user for the selected range; transmits the received review to the SNS server.

According to the third aspect of the present invention, the electronic book terminal according to the first or the second aspect of the present invention, further includes an open level specifying unit receiving the open level of the transmitted range from a user and transmitting the received open level to the SNS server

According to the third aspect of the present invention, the electronic book terminal according to the first or the second aspect of the present invention receives the open level of the transmitted range from a user and transmits the received open level to the SNS server.

According to the fourth aspect of the present invention, the electronic book terminal according to any one of the first to the third aspects of the present invention further includes:
an acquiring unit acquiring the transmitted range; and
an editing receiving unit receiving an editing of the acquired range.

According to the fourth aspect of the present invention, the electronic book terminal according to any one of the first to the third aspects of the present invention acquires the transmitted range; and receives an editing of the acquired range.

According to the fifth aspect of the present invention, an information sharing method executed by an SNS server sharing information among predetermined users and an electronic book terminal communicatively connected with the SNS server, includes the steps of:
displaying predetermined electronic book data;
selecting a range of the displayed electronic book data according to user's operation;
checking the page number and the content of the selected range;
judging whether or not the page number and the content of the selected range are transmittable to the SNS server; and
transmitting the selected range to the SNS server according to the open level.

According to the sixth aspect of the present invention, a program product for use in an electronic book terminal communicatively connected with an SNS server sharing information among predetermined users, including a non-transitory computer usable medium having a set of instructions physically embodied therein, the set of instructions including computer readable program code, which when executed by the electronic book terminal causes the information processing unit to:
display predetermined electronic book data;
select a range of the displayed electronic book data according to user's operation;
check the page number and the content of the selected range;
judge whether or not the page number and the content of the selected range are transmittable to the SNS server; and
transmit the selected range to the SNS server according to the open level.

The present invention can provide an electronic book terminal, an information sharing method, and a program for the electronic book terminal that hardly cause copyright infringement when the information is shared through SNS.

### BRIEF DESCRIPTION OF DRAWINGS

FIG. 1 shows the overall view of an information sharing system 1 according to a preferable embodiment of the present invention.

FIG. 2 shows the functional block diagram of an electronic book terminal 10 and an SNS server 100 to illustrate the relationship among the functions.

FIG. 3 shows the flowchart executed by the electronic book terminal 10 and the SNS server 100.

FIG. 4 shows the flowchart executed by the electronic book terminal 10 and the SNS server 100.

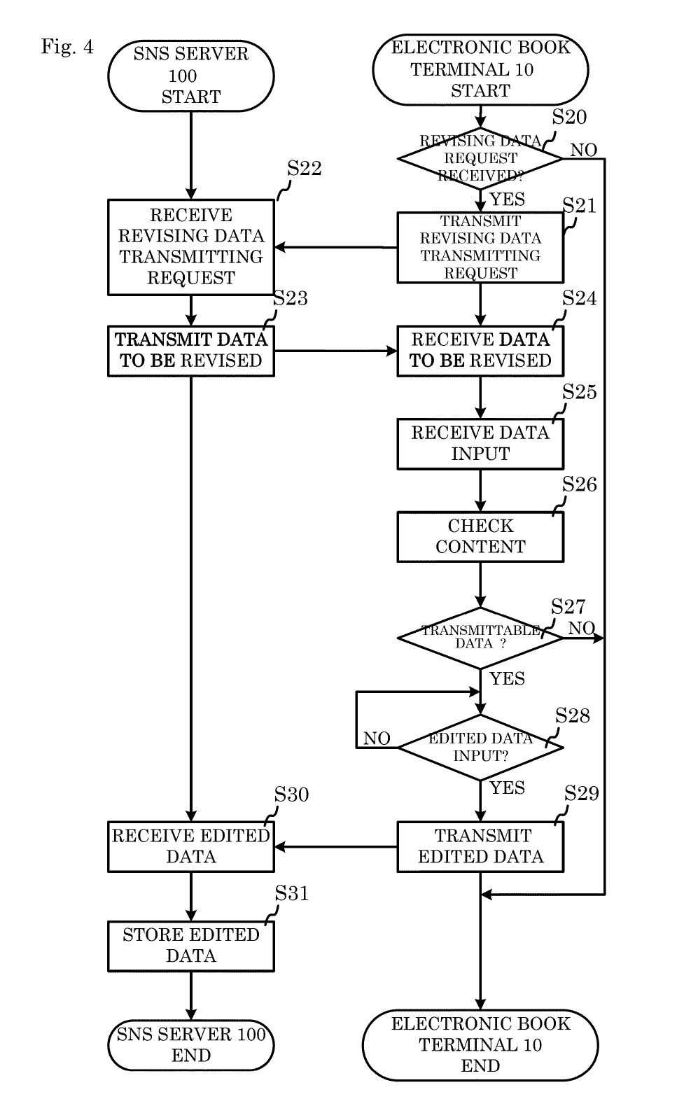

FIG. 5 shows the electronic book terminal 10 according to an embodiment of the present invention.

FIG. 6 shows the enlarged view of a posting window 50.

FIG. 7 shows a content information table.

### DESCRIPTION OF EMBODIMENTS

Hereinafter, a preferable mode of the present invention will be described below with reference to the accompanying drawings. However, this is illustrative only, and the scope of the present invention is not limited thereto.

### Overview of Information Sharing System 1

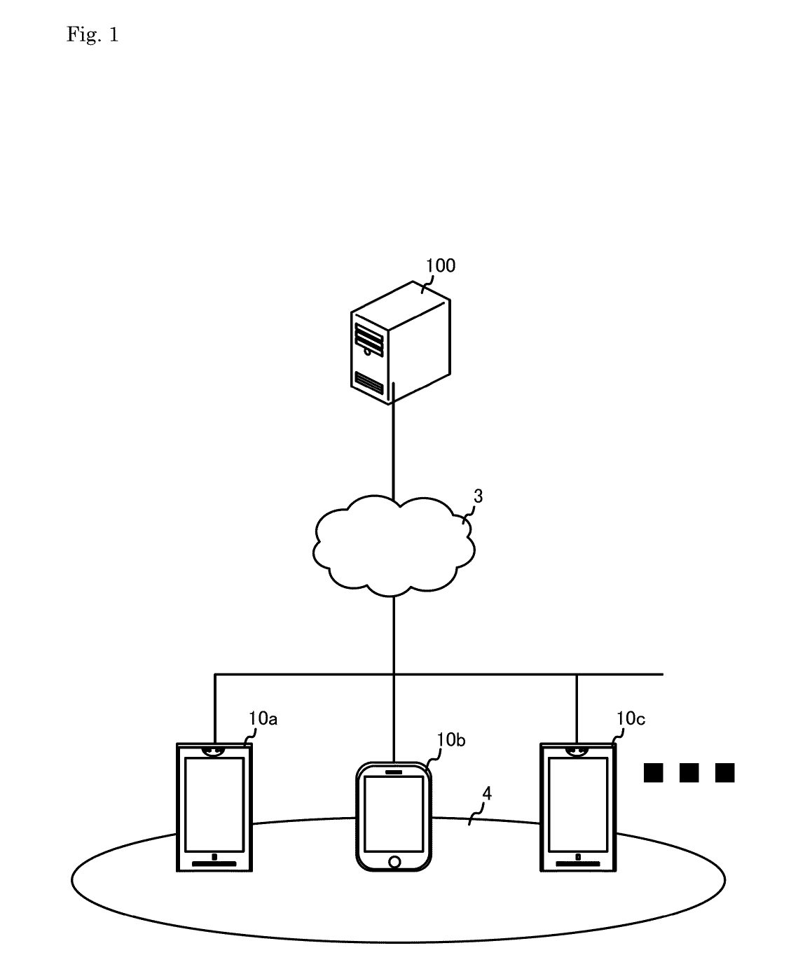

FIG. 1 shows the overall view of an information sharing system 1 according to a preferable embodiment of the present invention. The overview will be described below with reference to FIG. 1.

In the information sharing system 1, a plurality of electronic book terminals 10a, 10b and 10c (hereinafter simply referred to as “electronic book terminals 10,” unless otherwise explicitly stated) and the SNS server 100 composes an SNS 4.

SNS is a social network consisted of computer systems and enables the users of the electronic book terminals 10 to express their sociality among their defined relationships with the other users. The common relationships includes, but not limited to, relationships with friends, followers that transmit and receive selective information, and communities for specific subjects.

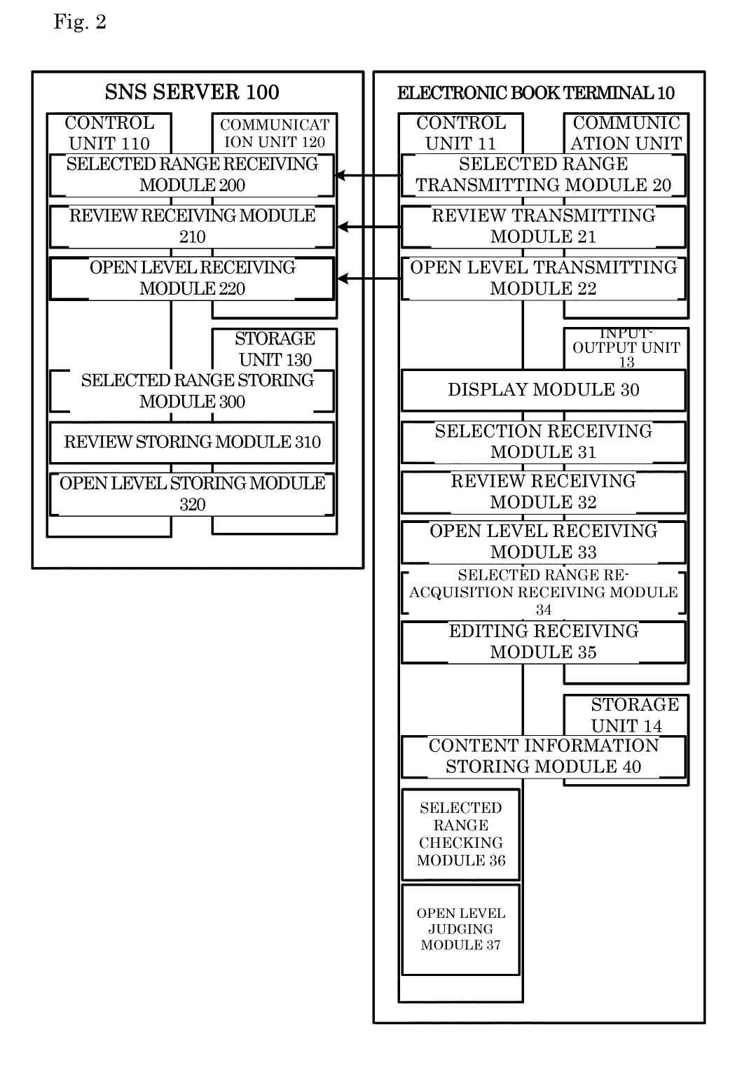

FIG. 2 is a block diagram illustrating an information sharing system 1 according to a preferable embodiment of the present invention. The information sharing system 1 includes a plurality of electronic book terminals 10, an SNS server 100, a public network 3 (the Internet network, a third generation network, a fourth generation network, etc.), and an SNS4.

The electronic book terminals 10 and the SNS server 100 are communicatively connected via the public network 3. The SNS 4 is composed of the server 100 connecting to the electronic book terminals 100. The SNS 4 may be composed of accounts logging-in from the terminals.

The electronic book terminals 10 may be common information terminals such as an information appliance and an electric appliance described below. The electronic book terminals 10 may include not only a mobile phone, a smartphone, a multi-function printer, a television, and network devices such as a router and a gateway, a computer but also white goods such as a refrigerator, a washing machine and common home information appliances such as a telephone, a netbook computer, a slate device, an electronic book terminal, a portable music player, a portable content recording and reproducing device.

The SNS server 100 is a component of the SNS and provides the electronic book terminals 10 with information posted by the users as described below.

### Functions

FIG. 2 is the functional block diagram of an electronic book terminal 10 and an SNS server 100 to illustrate the relationship among the functions.

The electronic book terminal 10 includes: a control unit 11 provided with CPU (Central processing Unit), RAM (Random Access Memory), ROM (Read Only Memory), etc.; and a communication unit 12, for example, a wireless device such as a Wi-Fi® (Wireless Fidelity) device conforming to the IEEE 802.11 standard or a third generation mobile communication system conforming to the IMT-2000 standard, etc. or a wired LAN device.

The electronic book terminal 10 also includes, as the input-output unit 13, a display unit outputting data and images controlled by the control unit 11; and a touch panel, a keyboard, a mouse, etc. which receive an input from a user.

Furthermore, the electronic book terminal 10 includes, as the storage unit 14, a data storage unit including a hard disk, and a semiconductor memory.

The electronic book terminal 10 runs the selected range transmitting module 20, the review transmitting module 21, and the open level transmitting module 22 by a predetermined program read to the control unit 11 in cooperation with the communication unit 12. The electronic book terminal also runs the display module 30, the selection receiving module 31, the review receiving module 32, the open level receiving module 33, the selected range re-acquisition receiving module 34 and the editing receiving module 35 by a predetermined program read to the control unit 11 in cooperation with the input-output unit 13. The electronic book terminal 10 also runs the selected range checking module 36 and the open level judging module 37 by a predetermined program read to the control unit 11 read to the control unit 11. The electronic book terminal 10 also runs the content information storing module 40 by a predetermined program read to the control unit 11 in cooperation with the storage unit 14.

The SNS server 100 includes, as the control unit 110, CPU, RAM, ROM, etc. and, as the communication unit 120, for example, a Wi-Fi® device conforming to the IEEE 802.11 standard, or a wired LAN device. The SNS server 100 also includes, as the storage unit 130, a data storage unit such as a hard disk or a semiconductor memory.

The SNS server 100 runs the selected range receiving module 200, the review receiving module 210, the open level receiving module 220 by a predetermined program read to the control unit 11 in cooperation with the communication unit 120. The SNS server 100 also runs the selected range storing module 300, the review storing module 310, the open level storing module 320 by a predetermined program read to the control unit 11 in cooperation with the storage unit 130.

### SNS Posting Process

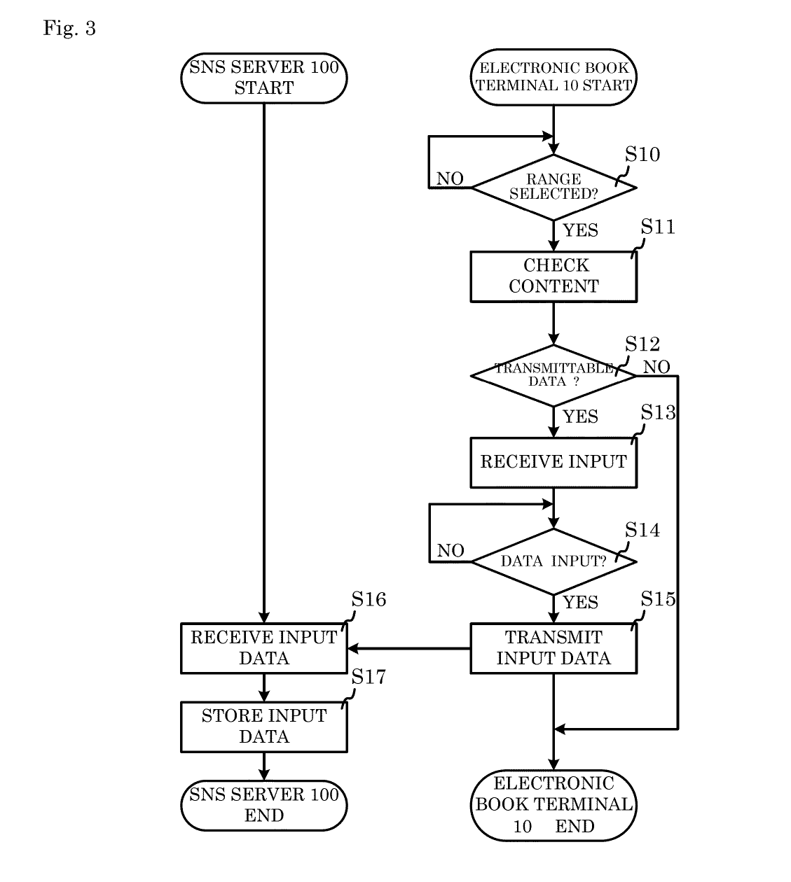

FIG. 3 is a flowchart showing SNS posting process executed by the electronic book terminal 10 and the SNS server 100. The tasks executed by the modules will be described below with this process.

The process assumes that a user purchases and reads electronic book data through the electronic book terminal 10 by ordering and downloading the electronic book data which he or she wishes to read from an electronic book server not shown in the figures. The detailed description concerning this process will be left out because it is not the subject-matter of the present invention.

At the beginning, the electronic book terminal 10 judges whether or not the user has selected a content such as a character string and/or an image of the electronic book data which the user wishes to post on SNS (Step S10). If the user has not at the step 10 (NO), then the process is terminated (Step S11).

The display module 30 of the electronic book terminal 10 displays electronic book data. The selection receiving module 31 of the electronic book terminal 10 receives an input from the user. The input includes a selection of character string, a selection of specific range of character string, a copying of the selected character string, a selection of image, a selection of specific range of image, an input of characters, and a selection of items. It goes without saying that the input may include other contents.

How the user selects a content will be described below.

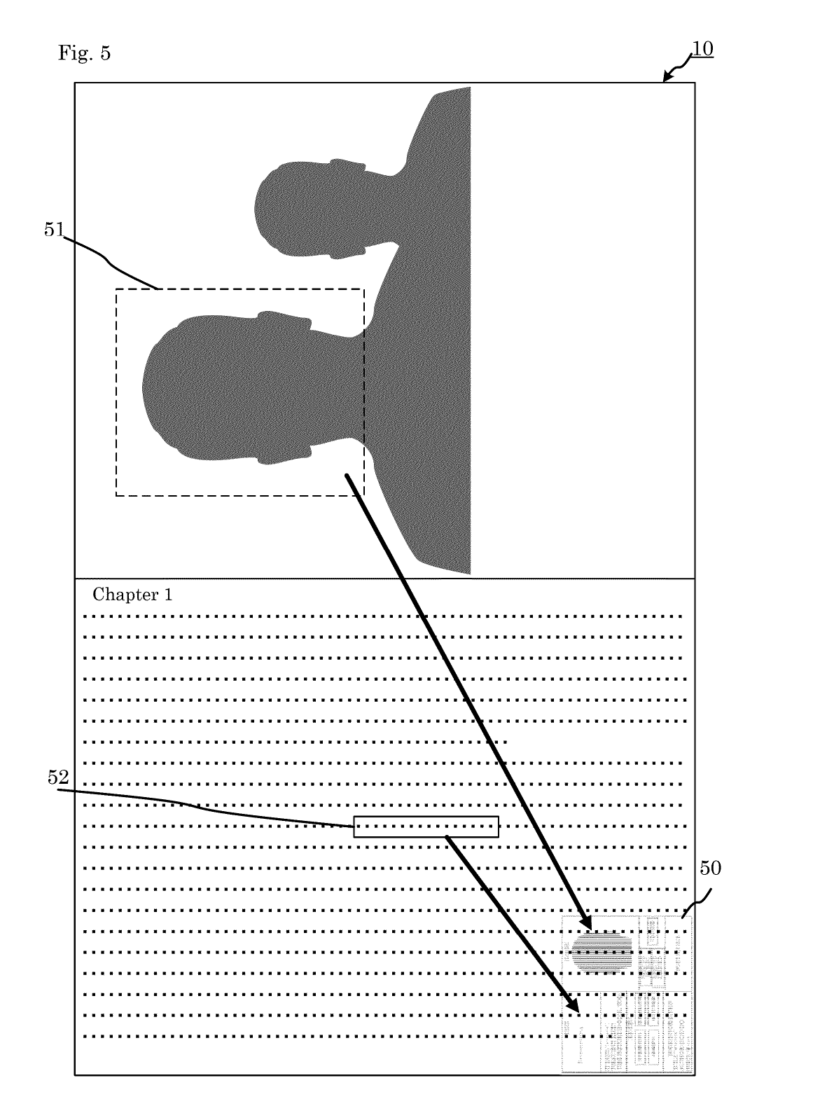

FIG. 5 shows electronic book data being read by a user on the electronic book terminal 10 according to an embodiment of the present invention.

First, the case that a user selects an image to the posting window 50 will be described below.

A user selects a range of the image which he or she wishes to post on SNS. The selection receiving module 31 of the electronic book terminal 10 receives a selection from the user. Specifically, the user selects a range of the image which he or she wishes to post on SNS by the image selection frame 51. The user drags the image selected by the image selection frame 51 to the posting window 50. The storage unit 14 of the electronic book terminal 10 stores the image which has been dragged to the posting window 50.

The shape of the image selection frame 51 is not limited to a rectangle and may be other shapes. The selection receiving module 31 of the electronic book terminal 10 may receive an image itself or a range of image that the user has selected, in a different way. The image selected by the image selection frame 51 may be displayed without being dragged by the user.

Next the case that a user selects a character string to the posting window 50 will be described below.

The user selects a character string which he or she wishes to post on SNS. The selection receiving module 31 of the electronic book terminal 10 receives a selection by the user. Specifically, the user selects the character string which he or she wishes to post on SNS by the text selection frame 52. The user drags the character string selected by the text selection frame 52 to the posting window 50. The storage unit 14 of the electronic book terminal 10 stores the character string which has been dragged to the posting window 50.

The shape of the text selection frame 52 is not limited to a rectangle and may be other shapes. The selection receiving module 31 of the electronic book terminal 10 may receive the character string itself or a range of character string that the user has selected, in a different way. The character string selected by the text selection frame 52 maybe displayed without being dragged by the user.

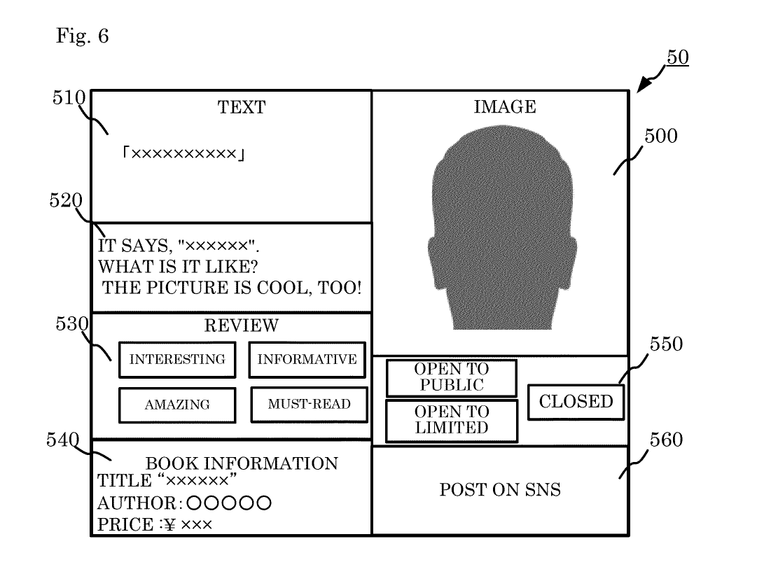

Next, the posting window 50 will be described below. FIG. 6 is the enlarged view of a posting window 50.

As shown in FIG. 6, the posting window 50 provided with the image frame 500, the text frame 510, the comment posting frame 520, the review frame 530, the book information frame 540, the open level specifying frame 550, and the SNS posting frame 560.

The display module 30 of the electronic book terminal 10 displays the posting window 50 in the electronic book terminal 10. The display module 30 of the electronic book terminal 10 displays the image received by the selection receiving module 31 in the image frame 500. The display module 30 of the electronic book terminal 10 also displays the character string received by the selection receiving module 31 in the text frame 510. The display module 30 of the electronic book terminal 10 receives an input from the user and displays the inputted comment for SNS in the comment posting frame 520. The display module 30 of the electronic book terminal 10 also displays a plurality of previously set reviews, such as “interesting,” “informative,” “amazing,” “must-read” in the review frame 530. The display module 30 of the electronic book terminal 10 also displays information on the electronic book data such as the title, the author, and the price that are being displayed in the electronic book terminal 10, in the book information frame 540 of the electronic book terminal 10. The display module 30 of the electronic book terminal 10 also displays the open level to SNS that the user has specified in the open level specifying frame 550. The display module 30 of the electronic book terminal 10 also displays the SNS posting frame 560 which receives an input to be posted on SNS by the user.

The posting window 50 shown in FIG. 6 is merely one example. The image frame 500, the text frame 510, the comment posting frame 520, the review frame 530, the book information frame 540, and the open level specifying frame 550 may be laid out differently. Unnecessary frames, for example, the comment posting frame 520 and the review frame 530 may be deleted. The image frame 500, the text frame 510, and the comment posting frame 520 may be merged into a one frame. Furthermore, other frames may be added.

If the range is selected (YES) at the step S10, the selected range checking module 36 of the electronic book terminal 10 checks the selected character string and the selected image (Step S11). At the step S11, the selected character string and the selected image are checked based on the content information table which has been previously stored by the content information storing module 40 of the electronic book terminal 10.

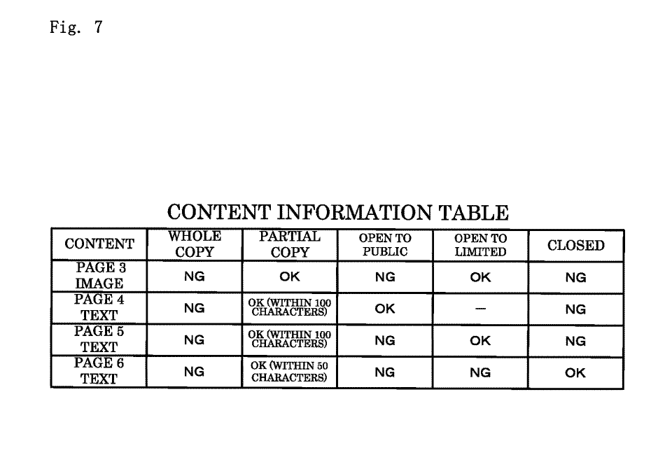

FIG. 7 shows the content information table. As shown in FIG. 7, the content information storing module 40 of the electronic book terminal 10 associates and stores contents with, a copyable level and an open level. Specifically, the content information storing module 40 of the electronic book terminal 10 stores whether or not the content in each page of the electronic book data is copyable and whether or not the content in each page of the electronic book data is open to the public on SNS. “Whole copy” means that a whole image and a whole character string are copyable. “Partial copy” means that an image and a character string are partially copyable. “Open to public” means that all the SNS members can view the content. “Open to limited” means that the limited SNS members can view the content. “Limited SNS members” mean the individuals previously specified by a user, groups previously specified by the user which are registered by a plurality of persons, and persons relating to a specific key word previously specified by the user. “Closed” means that only oneself can view the content. Furthermore, “limited SNS members” may be specified in a different way.

The content information storing module 40 of the electronic book terminal 10 also associates and stores the content information table associating page numbers with a content (an image and a character string), a copyable range, and an open level.

The copyable range is stored as the range previously set by the copyright holder. The copyable range in which the copyright has not been expired yet and which has not previously been set may be specified automatically as “partial copy.” The copyable range in which the copyright has been already expired may be specified as “whole copy.”

The open level may be specified by the user at will. Specifically, the open level receiving module 33 of the electronic book terminal receives the open level specified by the user. The open level specified by the user includes “open to public,” “open to limited,” and “closed.” A user specifies the open level of the content of each page.

Next, the content information table will be described below. In the content information table shown in FIG. 7, at “Page 3 image,” “whole copy” is “NG,” “partial copy” is “OK,” “open to public” is “NG,” “open to limited” is “OK,” and “closed” is “NG.”

“Page 3 image” means that the page 3 has an image. When “Whole copy” is “NG,” the whole range of the image is not copyable. When “Partial copy” is “OK,” the image is partially copyable. When “Open to public” is “NG,” “open to limited” is “OK,” and “closed” is “NG,” the open level of the image, comment, etc. contained in the selected range are “open to the limited.”

At “Page 4 text,” “whole copy” is “NG,” “partial copy” is “OK” (within 100 characters), “open to public” is “OK,” “open to limited” is “-,” and “closed” is “NG.”

“Page 4 text” means that the page 4 has a character string. When “Whole copy” is “NG,” the whole character string is not copyable. When “Partial copy” is “OK” (within 100 characters), the character string is copyable within 100 characters. When “open to public” is “OK,” “open to limited” is “-,” and “closed” is “NG,” the open level of the character string and the comment, etc. posted on SNS are open to the public. The reason why “open to limited” is “-” is because the posted content open to the public does not need to be open to the limited.

At “Page 5 text,” “whole copy” is “NG,” “partial copy” is “OK” (within 100 characters), “open to public” is “NG,” “open to limited” is “OK,” and “closed” is “NG.”

“Page 5 text” means that the page 5 has a character string. The case that “whole copy” is “NG” is the same as is the case described above. The case that “partial copy” is “OK” (within 100 characters) is the same as is the case described above. When “open to public” is “NG,” “open to limited” is “OK,” and “closed” is “NG,” the open level of the character string and the comment, etc. posted on SNS are “open to limited.”

“Page 6 text” means that “whole copy” is “NG” , “partial copy” is “OK” (within 50 characters), “open to public” is “NG,” “open to limited” is “NG,” and “closed” is “OK.”

“Page 6 text” means that the page 6 has a character string. The case that “whole copy” is “NG” is the same as is the case described above. The case that “partial copy” is “OK” (within 50 characters) is the same as is the case described above except that a character string within only 50 characters is copyable. When “open to public” is “NG,” “open to limited” is “NG,” and “closed” is “OK,” the open level of the character string and the comment, etc. posted on SNS is closed to but oneself.

At the step S11, the selected range checking module 36 of the electronic book terminal 10 checks the page number and the details of the content which are selected and dragged to the posting window 50 based on the content information table. Then, the open level judging module 37 of the electronic book terminal 10 judges whether or not the page number and the details of the content checked by the selected range checking module 36 are transmittable to the SNS server 100 (Step S12).

At the step S12, the open level judging module 37 of the electronic book terminal 10 judges whether or not the content received by the selection receiving module 31 are within the range of the specified values set in the content information table.

Specifically, as shown in FIG. 5, the open level judging module 37 of the electronic book terminal 10 judges whether or not the image and the character string selected by the user are within the range set in the content information table.

The open level judging module 37 judges that the selected range of the image received by the selection receiving module 31 is within the range set in the content information table when the number of pixels in the selected range of the image is within the predetermined number of pixels. This judgement may be carried out in a different way.

The open level judging module 37 judges that the selected range of the character string received by the selection receiving module 31 is within the range set in the content information table when the number of characters in the selected range of the character string is within the predetermined number of characters. This judgement may be carried out in a different way.

If judging that the content which is received by the selection receiving module 31 is beyond the range set in the content information table (NO) at the step S12, the open level judging module 37 of the electronic book terminal 10 notifies the user of the judgement result and terminates this process.

If judging that the content which is received by the selection receiving module 31 is within the range set in the content information table (YES) at the step S12, the open level judging module 37 of the electronic book terminal 10 receives an input from the user (Step S13).

At the step S13, the user inputs his or her comment in the comment posting frame 520 shown in FIG. 6. The comment posting frame 520 may display the selected character string and image.

Then, at the step S13, the review receiving module 32 of the electronic book terminal 10 receives, an input as well as a review from the user.

As shown in FIG. 6, the review which is received by the review receiving module 32 is selected by the user from a plurality of reviews displayed in the review frame 530. Instead of selecting a review from the reviews previously displayed in the review frame 530, the user may directly input a review.

At the step S13, the open level receiving module 33 of the electronic book terminal 10 receives an input of the open level of the posted comment.

As shown in FIG. 6, the open level received by the open level receiving module 33 is selected by the user from a plurality of previously set open levels displayed in the open level specifying frame 550. The open level may not be specified by a user, but the open level stored in the content information table may be used.

The selection receiving module 31 of the electronic book terminal 10 judges whether or not the user has instructed to post on SNS (Step S14). At the step S14, the electronic book terminal 10 judges whether or not an input has been transmitted from the user to the SNS posting frame 550 of the posting window 50.

If judging that no input has been transmitted to the SNS posting frame 550 of the posting window 50 (NO), the electronic book terminal 10 waits for an input from the user.

If judging that an input to the SNS posting frame 550 is received (YES), the electronic book terminal 10 transmits various data inputted by a user to the SNS server 100 (Step S15). At the step S15, the selection frame transmitting module 20 of the electronic book terminal 10 transmits the selected image, character string, and posted comment to the SNS server 100. Furthermore, the review transmitting module 21 of the electronic book terminal 10 transmits the inputted review to the SNS server 100. Still furthermore, the open level transmitting module 22 of the electronic book terminal 10 transmits the inputted open level to the SNS server 100.

The SNS server 100 receives various data transmitted from the electronic book terminal 10 (Step S16). At the step S16, the selected range receiving module 200 of the SNS server 100 receives the selected image, character string, or posted comment transmitted from the electronic book terminal 10. Furthermore, the review receiving module 210 of the SNS server 100 receives the review transmitted from the electronic book terminal 10. Still furthermore, the open level receiving module 220 of the SNS server 100 receives the open level transmitted from the electronic book terminal 10.

The SNS server 100 stores the received various data in the storage unit 130 (Step S17). The selected range storing module 300 of the SNS server 100 stores the received image, character string or posted comment. Furthermore, the review storing module 310 of the SNS server 100 stores the received review. Still furthermore, the open level storing module 320 of the SNS server 100 stores the received open level.

The SNS server 100 presents the stored various data as the data posted by the user to viewers based on the set open level.

### SNS Posting Revising Process

The editing receiving module 35 of the electronic book terminal 10 judges whether or not a request to revise the various data posted on the SNS server 100 has been received (Step S20). At the step S20, if judging that a revising request has not been received from the user (NO), the editing receiving module 35 terminates this process.

At the step S20, if the editing receiving module 35 of the electronic book terminal 10 judges that a revising request has received from a user (YES), the electronic book terminal 10 transmits a revised data transmitting request to the SNS server 100 (Step S21).

The SNS server 100 receives the revised data transmitting request from the electronic book terminal 10 (Step S22). The SNS server 100, based on the received revised data transmitting request, transmits stored inputted data as the data to be revised to the electronic book terminal 10 (Step S23). The electronic book terminal 10 receives the data to be revised from the SNS server 100 (Step S24)

The electronic book terminal 10 displays the received data to be revised in the posting window 50. The electronic book terminal 10 receives receive a revising of data from the user in this posting window 50 (Step S25). At the step S25, the revising of data from the user is to partially or totally revise data including the posted content, the open level, the character string, the image, and the review.

At the step S25, the selected range re-acquisition receiving module 34 of the electronic book terminal 10 receives the selected range different from the previously selected range. The received range is displayed in the image frame 500 or in the text frame 510 of the posting window 50. At the step S25, the selected range checking module 36 of the electronic book terminal 10 checks the selected character string and the selected image based on the content information table stored in the content information storing module 40 of the electronic book terminal 10 (Step S26). The step S26 is processed in the same way as the above-mentioned step S11.

Then, the open level judging module 37 of the electronic book terminal 10 judges whether or not the page number and the details of the content checked by the selected range checking module 36 are transmittable to the SNS server 100 (Step 27).

At the step S27, the open level judging module 37 of the electronic book terminal 10 judges whether or not the content received by the selected range re-acquisition receiving module 34 is within the range set in the content information table. The step S27 is processed in the same way as the above-mentioned step S12.

At the step S27, if judging that the content received by the selected range re-acquisition receiving module 34 is beyond the range set in the content information table (NO), the open level judging module 37 of the electronic book terminal 10 notifies the user of the judgement result and terminates this process.

At the step S27, if the open level judging module 37 of the electronic book terminal 10 judges that the content received by the selected range re-acquisition receiving module is within the range set in the content information table (YES), then the editing receiving module 35 of the electronic book terminal 10 judges whether or not edited data have been input (Step S28). At the step S28, the editing receiving module 35 judges whether or not an input has been transmitted from the user to the SNS posting frame 550 of the posting window 50. The step S28 is processed in the same way as the above-mentioned step S14.

If judging that no input has been transmitted to the SNS posting frame 550 (NO), the electronic book terminal 10 waits for an input from the user.

If judging that an input has been transmitted to the SNS posting frame 550 (YES), the electronic book terminal 10 transmits the various data edited by the user to the SNS server 100 (Step S29).

At the step S29, the selection frame transmitting module 20 of the electronic book terminal 10 transmits the edited image, the edited character string, or the edited comment to the SNS server 100. Furthermore, the review transmitting module 21 of the electronic book terminal 10 transmits the inputted review to the SNS server 100. Still furthermore, the open level transmitting module 22 of the electronic book terminal 10 transmits the inputted open level this time to the SNS server 100.

The SNS server 100 receives the various edited data transmitted from the electronic book terminal 10 (Step S30). At the step S30, the selected range receiving module 200 of the SNS server 100 receives the edited image, the edited character string or the edited comment from the electronic book terminal 10. Furthermore, the review receiving module 210 of the SNS server 100 receives the edited review transmitted from the electronic book terminal 10. Still furthermore, the open level receiving module 220 of the SNS server 100 receives the edited open level transmitted from the electronic book terminal 10.

The SNS server 100 stores the received edited various data in the storage unit 130 (Step S31). The selected range storing module 300 of the SNS server 100 stores the received image, the received character string, or the received posted comment. Furthermore, the review storing module 310 of the SNS server 100 stores the received review. Still furthermore, the open level storing module 320 of the SNS server 100 stores the received open level.

According to this embodiment of the present invention, all the edited data are transmitted to the SNS server 100, but only the revised data is transmitted to and stored in the SNS server.

The SNS server 100 presents the stored various data as the data edited by the user to viewers based on the set open level.

To achieve the means and the function that are described above, a computer (including CPU, an information processor, and various terminals) reads and executes a predetermined program. For example, the program is provided in the form recorded in a computer-readable medium such as a flexible disk, CD (CD-ROM, etc.), and DVD (DVD-ROM, DVD-RAM, etc.). In this case, a computer reads a program from the recording medium, forwards and stores the program to and in an internal or an external storage, and executes it. The program may be previously recorded in, for example, a storage (recording medium) such as a magnetic disk, an optical disk, and a magneto-optical disk and provided from the storage to a computer through a communication line.

The embodiment of the present invention is described above. However, the present invention is not limited to the above-mentioned embodiments. The effect described in the embodiments of the present invention is only the most preferable effect produced from the present invention. The effect of the present invention is not limited to those described in the embodiments of the present invention.
1 information sharing system
3 public network
4 SNS
10 electronic book terminal
100 SNS server

What is claimed is:

1. An electronic book terminal communicatively connected with an SNS server sharing information among predetermined users, comprising:
a display unit displaying predetermined electronic book data;
a selection receiving unit selecting a range of the displayed electronic book data according to user's operation;
a selected range checking unit checking the page number and the content of the selected range;
an open level judging unit judging whether or not the page number and the content of the selected range are transmittable to the SNS server; and
an SNS posting unit transmitting the selected range to the SNS server according to the open level.

2. The electronic book terminal according to claim 1, further comprising:
a review receiving unit receiving a review from a user for the selected range; and
an SNS posting unit transmitting the received review to the SNS server.

3. The electronic book terminal according to claim 1, further comprising an open level specifying unit receiving the open level of the transmitted range from a user and transmitting the received open level to the SNS server.

4. The electronic book terminal according to claim 3, further comprising:
a review receiving unit receiving a review from a user for the selected range; and
an SNS posting unit transmitting the received review to the SNS server.

5. The electronic book terminal according to claim 1, further comprising:
an acquiring unit acquiring the transmitted range; and
an editing receiving unit receiving an editing of the acquired range.

6. The electronic book terminal according to claim 5, further comprising:
a review receiving unit receiving a review from a user for the selected range; and

7. The electronic book terminal according to claim 5, further comprising an open level specifying unit receiving the open level of the transmitted range from a user and transmitting the received open level to the SNS server.

8. An information sharing method executed by an electronic book terminal communicatively connected with an SNS server sharing information among predetermined users, comprising the steps of:
displaying predetermined electronic book data;
selecting a range of the displayed electronic book data according to user's operation;
checking the page number and the content of the selected range;
judging whether or not the page number and the content of the selected range are transmittable to the SNS server; and
transmitting the selected range to the SNS server according to the open level.

9. A program product for use in an electronic book terminal communicatively connected with an SNS server sharing information among predetermined users, comprising a non-transitory computer usable medium having a set of instructions physically embodied therein, the set of instructions including computer readable program code, which when executed by the electronic book terminal causes the information processing unit to:
display predetermined electronic book data;
select a range of the displayed electronic book data according to user's operation;
check the page number and the content of the selected range;
judge whether or not the page number and the content of the selected range are transmittable to the SNS server; and
transmit the selected range to the SNS server according to the open level.
